(19) United States
(12) Patent Application Publication
(10) Pub. No.: US 2009/0176678 A1
(43) Pub. Date: Jul. 9, 2009

(54) SOLUTION AND METHOD FOR CLEANING AND RESTORATION OF HEADLIGHT LENSES

(76) Inventors: Dean Zeisbrich, Roseville, CA (US); Teresa C. Estrada, Roseville, CA (US)

Correspondence Address: SCHNECK & SCHNECK, P.O. BOX 2-E, SAN JOSE, CA, 95109-0005, US

(21) Appl. No.: 12/353,127

(22) Filed: Jan. 13, 2009

Related U.S. Application Data
(63) Continuation-in-part of application No. 12/172,094, filed on Jul. 11, 2008.
(60) Provisional application No. 60/949,197, filed on Jul. 11, 2007.
(60) Provisional application No. 61/030,182, filed on Feb. 20, 2008.

(51) Int. Cl. C11D 3/12

(52) U.S. Cl. 510/243

(57) ABSTRACT

A cleaning solution for plastic headlight covers includes a saturation of crystallizable salts, such as ammonium sulfate or urea; an organic solvent, such as a terpene, glycol ether or alkyl alcohol; a buffered acid to maintain a pH between 3.0 and 5.5, such as citric acid, oxalic acid, sodium bisulfate, or boric acid; alumina nanoparticles of 0.05 micron size and other submicron sizes; as well as a sequestering (chelating) agent, surfactant, and hydrophilic combiner; all in an aqueous solution. The cleaning solution effectively removes the mineral solids from the crazed surface of a plastic headlight cover that form a base for accumulating organic residue and road grime. No abrasive scouring or recoating of the surface with an acrylic sealant is required.

### CROSS-REFERENCE TO RELATED APPLICATIONS

This is a continuation-in-part of application Ser. No. 12/172,094, filed Jul. 11, 2008, which in turn claims priority under 35 U.S.C. 119(e) from U.S. provisional application No. 60/949,197, filed Jul. 11, 2007 by Dean Zeisbrich et al. for “Solution and Method for Cleaning and Restoration of Plastic Composite Headlight Material”.

### TECHNICAL FIELD

The present invention relates to a solution and method for cleaning and restoration of plastic material and more specifically cleaning and restoration of polycarbonate headlight lenses used in vehicles, such as the lens covers for headlights and taillights of automobiles, motorcycles, trucks, and other motor vehicles, as well as in aircraft canopies.

### BACKGROUND ART

Plastic materials are currently in widespread use for a number of products having exposure to the outside environment. A number of the properties of plastic have resulted in their widespread use. These advantages include the fact that plastics are generally inexpensive, light-weight, relatively easy to mold or shape, and may be made transparent or even colored to allow use as an indicator light that would be seen as having a selected color. For these reasons, plastic materials, such as polycarbonates, have been widely adopted in the motor vehicle industry, including their use as lens covers secured over headlights and taillights.

Plastic headlight and taillight lens covers are subject to demanding environmental and physical conditions. They receive UV radiation from exposure to sunlight, thermal heating and cooling from environmental changes as well as from the use of the lights themselves, and exposure to rainwater, car washing with hard water, motor vehicle exhaust, road oils, salts and grime. As a result of the cumulative effects of these exposures, the plastic lens covers not only become dirty, but may also yellow and become cloudy, reducing the amount of light emitted.

Although the polycarbonate or other plastic lenses do suffer as a result of UV exposure, the yellowing that both industry and the public assume to be plastic failure as a result of UV exposure is an overstated culprit and a misconception. One reason for the misconception is that many people have tried to clean their headlights with conventional methods or cleaners and met with little or no success, as conventional cleaners, both household and industrial, are not formulated to remove the particular mineral contaminants that occur on the headlights.

The actual damage suffered by the lens due to UV exposure is primarily crazing of the surface of the lens. Although some yellowing does occur, it contributes to dimming to a much lesser degree. Polycarbonate, the primary material of headlight lenses, is well known for its expansive nature and its tendency to craze from exposure to UV light and temperature differences. This shortcoming of polycarbonate is further exasperated by the extremely hot conditions created by modern headlamps within the headlight structure.

Further compromising the lens is the fact that because of its extremely tough nature and tremendous resilience to impact, manufacturers have been able to build lenses that are thin and lightweight, while at the same time meeting the impact resistance requirements of the Department of Transportation. Unfortunately the thinness of these lenses has compromised their ability to resist expansion under heated conditions leading to crazing and providing the foothold for the initial buildup on the lens. Surface temperatures of a modern headlight lens, when running daylight, they can easily reach temperatures in excess of 150 degrees. These temperatures also give rise to another unique condition that plastic headlight lens are subjected to where the surface of the lens serves as an evaporative surface for water and humidity in the air and any other potential contaminants that are evaporated leaving the solids on the surface of the lens and in the opened crazed lens surface. These contaminants can include hydrocarbons, asphaltic content from the roadway, and mineral deposits from water, all of which find a foothold in the microscopically crazed surface of the lens. The particular minerals deposited in the surface may vary somewhat by geographic location, but the several forms of calcium and magnesium carbonates (calcite, aragonite, magnesite, etc.) appear to be the most common and tenacious of the accumulations. The deposits form in successive and initially very thin layers which are nearly undetectable by the naked eye until such a time as the accumulating deposits become larger and are more rapidly accumulated on the roughened profile below.

Unfortunately by the time these contaminants become concentrated enough as to give hold to larger and more easily formed particulate/contaminants as to be visible to the naked eye the problem is well beyond the practical use of conventional waxes and cleaners the likes of which can at best remove some yellowing but leave behind the true root of the problem, the mineral layer and leave the lens subject to a rapid re-yellowing in some cases the re-yellowing is worse than that which was partially removed. These visible effects vary from case to case, and generally become visible to the naked eye within about 3 years, but begin their deposition immediately upon exposure to the conditions presented with the use of the vehicle light.

Industry standard consists of several abrasive and/or coating systems and methods that have been stated and are designed to remove the aforementioned and improperly characterized UV-damaged plastic in an attempt to reveal an undamaged clear surface. These systems and methods often are offered as a permanent solution to the yellowing problem when in reality they at best offer a new starting point for the contamination to recommence. These methods are less efficient from a standpoint of time effectiveness, and continued serviceability of the lens. Further and more often than not, these methods serve to exasperate the condition that began in the headlight, a profile on the lens that is not smooth and is subject to future and more easily established build-ups. In addition, a common method of restoration involves a sanding and re-coating of the lens with any number of acrylic, lacquer, or other coating which is only a temporary fix as the build-up will establish itself on the coating either before or after the failure of that coating. It is best stated that industry and common misconception of the actual causes of the yellowed headlights, has led to their longstanding lack of proper maintenance as the cleaning systems above stated by manufacturer and the like will not remove the mineral deposits safely as they rely on mechanical abrasion with what is basically sandpaper, which are the root cause for the tremendous fouling of the lens leading to safety concerns and aesthetically unattractiveness.

It is an object to provide an alternative vehicle light lens cleaning product that is very inexpensive compared to existing methods, provides rapid results, gives rise to the ability to give regular care and maintenance to this long overlooked and neglected part of a vehicle, and can be used by unskilled users.

### SUMMARY DISCLOSURE

The invention is a vehicle lens cover cleaning solution containing: a minimum 30% by volume of a saturated solution of crystallizable salts, such as ammonium sulfate or urea; a buffered acid, such as citric acid, oxalic acid, sodium bisulfate or boric acid, sufficient to maintain the solution in a pH range between 3.0 and 5.5, at least 2% by volume of an organic solvent, such as one or more of a terpene (e.g., any isomer of limonene, pinene or camphor), a glycol ether or an alkyl alcohol; and at least 0.5% by volume dispersion of submicron-size non-soluble particles (“nanoparticles”) including at least 0.05 μm-size alumina (sapphire); all in aqueous solution. Additionally, the solution may contain one or more of at least 2% by volume of a surfactant; a sequestering agent, such as ethylenediaminetetraacetic acid (EDTA); and a hydrotropic combiner, such as sodium xylene sulfonate (SXS). The solution combines the degreasing activity of the organic solvent and optional surfactant, with the demineralizing activity of the buffered acid with sequestering agents. The crystallizable salts and the nanoparticles both aid the demineralizing activity of the acid, especially upon carbonate deposits (calcite, aragonite, magnesite, etc.) in the crazed plastic surface of the lens cover.

To restore plastic headlight covers that have become discolored and/or cloudy by the mineral deposits and accumulated organic residues and road grime, the solution is liberally applied to the headlight surface and allowed to remain for a few minutes until the treatment begins to crystallize. The lens cover is then wiped clean with a dry cloth using firm even pressure. No scouring is required. In cases of extreme build-up, restoration of the lens cover may benefit from a second repeat treatment, if needed. A regular schedule of maintenance using the treatment can extend the usable life of the headlight covers.

### DETAILED DESCRIPTION

The present solution and method remove build-up of contaminants on the surface of polycarbonate resulting in a much more optically clear lens cover and removal of mineral deposits. This improves both the appearance of the lens and the safety of the lens cover. The resulting surface is very smooth and resistant to future build-up of contaminants. The results are achieved without the use of tools or sandpaper, buffers, or other abrasion devices. The improved appearance of the cleaned plastic may be achieved in five minutes or less per lens cover, depending on humidity and climate conditions and lens condition.

The plastic lens covers are generally made of polycarbonate. Two general types of adherent material combine to discolor and cloud the plastic lens covers. The first type comprises mineral deposits, such as calcium carbonate or other minerals. These form tenacious insoluble buildup on the surface of the lens. The other is road grime, made up of dirt and hydrocarbon residues. The presence of the grime makes the removal of the mineral deposits much more difficult, while mineral deposits, if not removed, serve as a base for future deposits and inclusions of grime. The present invention has found that the combination of a solvent and a surfactant detergent is not sufficient by itself to restore the discolored lens covers, as they do not remove the mineral deposits from the lens surfaces. Even the addition of an acid is not sufficient to obtain adequate de-scaling activity, since the minerals form the underlying base of the grime deposits are formed within the crazed plastic surface. Several additional components are needed for full restoration of the plastic lens covers:

1. A concentrated solution of certain salts (such as ammonium sulfate or urea) that will rapidly crystallize on the lens surface.

Although the exact mechanism of action of the crystallized salts is not yet fully understood, the formation of the crystals is believed to draw into its formation the liberated contaminants from the lens via an acid reaction resulting in precipitate and a salt formation. The ammonium ions available from these salts also act as an astringent, removing water and bringing the nanoparticles into close contact with the lens contaminants, and possibly affecting the surface characteristics of both the lens and the contaminants, as the 0.05 μm size of the crystals is in the molecular range.

2. Submicron-sized, non-soluble “nanoparticles”, such as 0.05 μm-size alumina (sapphire) particles.

While the exact mechanism of action of these particles is not fully understood, it is believed that the nanoparticles act as a physical surfactant, acting particularly upon mineral structures of similar size and crystallization, such as aragonite. Surfactants and detergents are believed to adhere to the nanoparticles, which penetrate the grime on the lens. In addition, even without scrubbing or abrasion, the mere physical application of the solution containing particles of this specified size and hardness (of the hardness of a sapphire nanoparticle) is believed to cut into the grime and aid in bringing solvents and detergents through the grime to the adherent mineral deposits.

The concentrated salts and the nanoparticles, along with a buffered acid, are added to any standard cleaning solution, i.e., one containing an organic solvent and (optional) surfactant detergent. These components act in concert to both dissolve the hydrocarbon and other residues and road grime (the usual action of the solvent and surfactant), and also remove the mineral solids from the surface of the lens (the added action of the buffered acid, salts and nanoparticles). The solvents dissolve the hydrocarbon grime contaminants, including those found as inclusions within the layers of mineral deposits. The crystallizable ammonium or urea salts (and potentially additional astringents) connect the nanoparticles to very small pits and crevices within the crazed plastic material. As the contaminants are liberated from the surface of the lens, strong sequestered agents, such as EDTA, sodium bicarbonate, an sodium bisulfate, draw out the moisture and form a crystalline structure that has inclusions of hard abrasive nanoparticles. These nanoparticles serve to break up oxidized mineral contaminants on the lens surface. Rubbing off of the crystallized solution from the lens may also incidentally cause a highly efficient polishing of the lens. Together the treatment restores a nearly new appearance to the lens.

Examples of the crystallizable salts include those additionally serving as a source of ammonium ions, such as ammonium sulfate and urea. The former is a direct source of such ions and is preferred over the latter, which is only an indirect slow-release source of such ions.

Examples of suitable buffered acids include citric acid, oxalic acid, sodium bisulfate (NaHSO₄) and boric acid, when combined with the ammonium-based or other basic salts. Other stronger acids, such as ammonium bifluoride ((NH₄) (HF₂)) or hydrochloric acid (a.k.a., muriatic acid), could be used, but the strength of the acid or the pH of the overall solution before application is not nearly as important as the buffering capacity to maintain the acidity near the mineral surface as the de-scaling progresses. The buffering of the acidic solution should be such that a pH range from 3.0 to 5.5, and preferably from 4.0 to 4.5, will be maintained throughout the treatment process. As such, citric and oxalic acids are not only adequate, but even preferable for their high buffering capacity.

The acids may be combined with a sequestering (or chelating) agent, such as ethylenediaminetetraacetic acid (EDTA), to keep the dissolved calcium and other minerals removed by the acid from precipitating back onto the lens cover surface.

The nanoparticles should include at least 0.05 μm-size alumina (sapphire) particles, since their size and crystal structure are such that they act upon aragonite (rhombohedral CaCO₃) that is the major mineral species deposited within the pits and crevices of the crazed lens cover surface. Other size particles of alumina may be used (e.g., 0.3 μm and 1.0 μm) as an ultra-fine polish. Diamond powder or dust (25 μm or smaller; 800 mesh or greater) could even be used. However, the polishing effect is minor given the very brief wiping off of the applied composition. No scouring of the applied treatment is required or even desired. Any polishing effect should serve only to help remove existing mineral deposits. One should avoid creating additional pits and crevices in the already crazed plastic surface that could accelerate future mineral and organic depositions.

The organic solvent may include one or more of a terpene, a glycol ether and an alkyl alcohol. Terpene solvents comprise, e.g., various isomers of limonene and pinene, as well as various terpenoid derivatives, such as camphor. Common glycol ether solvents include diethylene glycol monoethyl ether (i.e., 2-(2-ethoxyethoxy)ethanol; CH₃CH₂OCH₂CH₂OCH₂CH₂OH) and ethylene glycol monobutyl ether (i.e., 2-butoxyethanol; CH₃CH₂CH₂CH₂OCH₂CH₂OH). However, many other glycol ethers also act as effective organic solvents and could be used. Alkyl alcohols that might be chosen include methanol, a common ingredient, e.g., in windshield wiper fluid, and isopropanol. The choice of organic solvents is based principally on how well it acts as a degreaser and removes the deposits of asphaltic and auto exhaust hydrocarbons and other organic residue from the lens covers. But other factors to consider in the selection of a suitable solvent include any adverse effects on the plastic material itself, as well as potential damage to paint surfaces if due care is not given when applying the solution, particularly in products that are intended for at-home use.

A small amount of any of several possible surfactants can be used. These include the aforementioned sequestering agent, EDTA, as well as common detergents (e.g., the various alkyl sulfonate anionic surfactants) found in window cleaners or windshield washer fluids.

When using organic solvents in an aqueous solution, the miscibility of the ingredients needs to be considered. A hydrotropic “combiner”, such as sodium xylene sulfonate (SXS), can be provided for compatibility to ensure that the various ingredients do not separate. Many surfactants can play a similar role.

A strong oxidant to help break down the organic surface residues may also be of some benefit. However, any such oxidant should be compatible with the primary ingredients, so as not to prematurely react in the acid environment of the solution or in the presence of ammonium ions and thereby lose its effectiveness or create noxious gases (chlorine, chloramines, etc). One oxidant that can be used, if desired, is hydrogen peroxide. Some inorganic per-compounds, such as sodium perborate, are also possible compatible oxidants, depending on the choice of the other ingredients.

In exemplary embodiments of the solution, the components may be as follows:

### Example Solution 1

3 parts dry EDTA (pH≈4) (CAS No. 60-00-4)
3 parts dry sodium bisulfate
3 parts dry citric acid
2 parts boric acid
10 parts ammonium sulfate
2 parts DOT-4 brake fluid (a source of glycol ethers)
3 parts white spirits (CAS No. 8052-41-3)
1 part 0.05 μm-size alumina (sapphire) powder
1 part 0.3 μm-size alumina (sapphire) powder
3 parts cationic surfactant
Adjust pH with Versene 100 (EDTA tetrasodium salt, 1% solution, pH≈9, CAS No. 64-02-8) and sodium bisulfate to a PH range of 4.0 to 4.5.

### Example Solution 2

Dissolve 750 g of dry EDTA into 26 fl. oz. (769 ml) of a 1-5% wt solution of oxalic acid (e.g., Zep Commercial™ Deck & Fence Cleaner). Add 26 fl. oz. (769 ml) of Westley's Bleche-Wite® Tire Cleaner (an aqueous solution containing isopropanol, 2-butoxyethanol, sodium metasilicate and sodium dodecyl benzene sulfonate), then add 6 fl. oz. (177 ml) of standard 1M hydrochloric (muriatic) acid. Add 36 fl. oz. (1065 ml) of a fully saturated solution of ammonium sulfate. Add 12 fl. oz. (355 ml) of DOT4 synthetic brake fluid (a mixture of glycols, glycol ethers and borate esters having a minimum 230° C. dry and 155° C. wet boiling point), 18 fl. oz. (532 ml) standard strength ammonia, 750 to 1500 g of dry ammonium sulfate, 8 oz. (227 g) of trisodium phosphate, 4 fl. oz. (118 ml) of SXS-40 (a solution of 30-60% wt of sodium xylene sulfate), 1 fl. oz. (30 ml) of 35% hydrogen peroxide, 50 to 150 g of boric acid, 26 to 50 fl. oz. of a petroleum solvent, and up to 33% vol. of a window cleaning fluid containing ammonia.

This example uses ammonium sulfate as the crystallizable salt. Additional ammonium ion sources are also provided and will react with some of the hydrochloric acid to produce ammonium chloride salts. For the buffered acid, it uses a combination of oxalic acid, boric acid and hydrochloric (muriatic) acid. It uses the sequestering agent EDTA. For the organic solvents, it uses a combination of glycol ethers, including 2-butoxyethanol, as well as isopropanol and petroleum distillates. It includes sodium dodecyl benzene sulfonate as a surfactant, and the hydrotropic combiner SXS for miscibility. Hydrogen peroxide is provided as an oxidant ingredient.

Finally, to this acidic solvent mixture, nanoparticles of at least 0.05 μm-size alumina are added in an amount making at least 0.5% of the total solution.

### Example Solution 3

1) 1 to 5% vol. SXS-40 (a solution of 30-60% wt of sodium xylene sulfate);

2) 1 to 5% vol. glycol ethers (typically found in non-silicone, i.e. DOT3 and DOT4, brake fluid);

3) Saturation quantities (15 to 80 g per liter) of ammonium sulfate;

4) 80 to 400 g per liter of dry EDTA.

This example uses ammonium sulfate as the crystallizable salts in saturated solution. The organic solvent comprises any of various glycol ethers. EDTA is a sequestering agent and surfactant. SXS is used as a hydrophilic combiner for miscibility of the solvent in the aqueous solution.

To this mixture, one or more buffered acids are added to lower the pH to the desired range (2.5 to 6.0) for use in de-scaling of mineral deposits, along with a quantity of nanoparticles.

### Example Solution 4

1) Urea (Hyper Concentrated solution): 30%-50%;

2) Citrus Terpene, Terpenoid or other citrus oil product (e.g., limonene): 2%-7% by volume;

3) Acetic Acid: 0.4-2.5 in solution pH CAS 64-19-7);

4) Citric Acid: 0.4-2.5 in solution pH CAS 77-92-9);

5) Alumina (sapphire) nanoparticles (0.05, 0.3 & 1.0 μm particle sizes): 1%-5% by volume;

6) Surfactant: 1%-5% by volume;

7) Rinse Agent: 1%-5% by volume;

8) Diamond powder or dust (at least 800 mesh): 0.05-0.5% by volume;

9) Silica: 5%-7% by weight;

10) Sodium hydroxide (Lye): 1%-3% by volume;

11) Ammonium bifluoride Detergents: 2%-10% by volume;

12) Commercially Available Windshield Cleaner Solution as remainder, or water.

This example uses urea as the crystallizable salt and forms a slow-release ammonium ion source. Buffered acids comprises a combination of acetic acid, citric acid and ammonium bifluoride with a sodium hydroxide base. The organic solvent is any citrus terpene (e.g., limonene) or a terpenoid derivative thereof. Methanol is also present, along with surfactants, in the commercial windshield cleaner. Alumina nanoparticles are used, along with an (optional) diamond powder.

In addition to the above components, there are a number of possible minor additives to the above solution, including:

Fragrance

Bittering Agent (to prevent accidental ingestion)

Gelling Agent

Colorant

### Example Solution 5

| Component | Amount per Gallon (3.785 liters) |
|---|---|
| Urea | 1200-1500 g. |
| Citric Acid | 200-300 g. |
| EDTA | 250-300 g. |
| Sodium Hydroxide | 200-300 g. (to adjust pH range to |
| | between 3.0 and 5.5) |
| Hydrogen Peroxide | 32-48 fl. oz. (946-1420 ml) |
| (3% solution in water) | |
| Isopropyl Alcohol | 32-48 fl. oz. (946-1420 ml) |
| (91% solution in water) | |
| Hexane or asphaltic | 32-48 fl. oz. (946-1420 ml) |
| distillate | |
| Ammonium sulfate | 100-200 g. |
| Sodium hydroxide | 150 g. |
| 0.05 μm sapphire | ⅛ to ¼ |
| Citrus terpene | 250-300 ml. |

Commercial windshield wiper fluid to fill gallon or water.
pH to between 3.5 and 4.5

In any of these formulas, an organic solvent and optional surfactant detergent (some from commercial products) are combined with buffered acids, concentrated crystallizable salts and nanoparticles. A number of different formulations have been tried. The specific pH may be in the range of 3.0-5.5 and should be heavily buffered to maintain the pH as the de-mineralization process progresses.

The present solution may be sold as a kit containing a pre-soaked applicator wrapped in plastic bottle and/or spray/foam. This might also conveniently include a pair of latex gloves to prevent skin exposure to the solution. The time and extent of application of these formulas will depend upon the condition of the lens to which the formulas are applied, but will usually take no more than 15 minutes. The formulas will restore any headlight lens.

What is claimed is:

1. A vehicle lens cover cleaning solution, comprising:
at least 30% vol of a saturated solution of crystallizable salts;
at least 2% vol of an organic solvent having at least one of a terpene, a glycol ether and an alkyl alcohol;
a buffered acid sufficient to maintain the solution in a pH range between 3.0 and 5.5; and
at least 0.5% vol of nanoparticles, including 0.05 μm size alumina (sapphire) particles, all in an aqueous solution.

2. A cleaning solution as in claim 1, wherein the crystallizable salts are selected from the group consisting of ammonium sulfate and urea.

3. A cleaning solution as in claim 1, wherein the terpene solvent is selected from the group consisting of any one or more of any isomer of limonene, pinene and camphor.

4. A cleaning solution as in claim 1, wherein the buffered acid is selected from the group consisting of any one or more of citric acid, oxalic acid, sodium bisulfate, and boric acid.

5. A cleaning solution as in claim 1, wherein the nanoparticles further include one or more additional sizes of alumina (sapphire) particles of at most 1 μm size.

6. A cleaning solution as in claim 1, further comprising at least 2% vol of a surfactant.

7. A cleaning solution as in claim 1, further comprising a sequestering agent.

8. A cleaning solution as in claim 7, wherein the sequestering agent is ethylenediaminetetraacetic acid (EDTA).

9. A cleaning solution as in claim 1, further comprising a hydrotropic combiner.

10. A cleaning solution as in claim 1, wherein the hydrotropic combiner is sodium xylene sulfonate (SXS).
